(19) United States
(12) Patent Application Publication
(10) Pub. No.: US 2003/0142395 A1
(43) Pub. Date: Jul. 31, 2003

(54) Coolerless pump wavelength optimization for Er/Yb-doped optical fiber amplifiers

(75) Inventors: Stuart MacCormack, Mountain View, CA (US); David Giltner, Fremont, CA (US); Ying Hua Zhang, Sharon, MA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/348,461

(22) Filed: Jan. 22, 2003

Related U.S. Application Data
(60) Provisional application No. 60/352,747, filed on Jan. 30, 2002.

(51) Int. Cl. H01S 3/00

(52) U.S. Cl. 359/341.3

(57) ABSTRACT

An optical fiber amplifier has a pump module operating at a shorter wavelength at room temperature than conventional optical fiber amplifiers. At the maximum operating case temperature, the output from the pump module is still at a lower wavelength than the upper absorption band edge of the optical fiber. In a further embodiment, an Er—Yb co-doped optical fiber is further doped with aluminum to flatten a portion of the optical absorption profile. Co-doping with aluminum reduces the sensitivity of optical amplifier output to wavelength drift of the pump module when pumped near the secondary peak.

### CROSS-REFERENCE TO RELATED APPLICATIONS

This applications claims priority of U.S. Provisional Patent Application No. 60/352,747 filed on Jan. 30, 2003, entitled “Coolerless Pump Wavelength Optimization for Er/Yb Doped Optical Fiber Amplifiers” which is incorporated herein by reference for all purposes.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to optical amplifiers and more specifically to optical fiber amplifiers with fibers doped to achieve a particular optical absorption spectrum.

### BACKGROUND OF THE INVENTION

Optical fiber amplifiers have found wide use in optical telecommunication and other applications. Optical fiber amplifiers can provide gain at the wavelengths that are desirable in optical communication systems, such as at nominally 1550 nm. Optical fiber amplifiers generally work by coupling light from a pump laser diode at a shorter wavelength (than the wavelength that gain is desired at) into the fiber. The photons from the pump laser diode excite electrons in atoms in the optical fiber, which then can collapse to a lower energy state to provide optical gain. The term “atoms” is used for the purpose of convenient discussion, and those of skill in the art will understand that the dopants in the glass lattice of the optical fiber are also often referred to as ions or ionized atoms.

Erbium(“Er”)-doped optical fibers have been found to provide gain in the desirable band of about 1550 nm. Typically Er-doped fibers are pumped with light centered aroung the 980 nm or 1480 nm pump bands. It has also been found that more than two orders of magnitude increase in the Er absorption can be achieved if the Er-doped fibers are co-doped with ytterbium (“Yb”). This in turn can provide higher efficiency and higher gain per unit length from the optical fiber amplifier. It is believed that the Yb atoms in the co-doped optical fiber absorb photons at the shorter wavelengths and transfer their absorbed energy to the Er atoms, thus enhancing absorption of the optical fiber amplifier.

The addition of Yb also increases the width of the pump band that can be used to excite the Er transition. The Yb absorption profile is typically comprised of a broad peak centered arougn 920 nm and a narrower absorption peak centered at 976 nm. Beyond 982 nm, the Yb absorption drops rapidly and any pump light beyond this wavelength will make a minimal contribution to the Er gain. Therefore, . in order to provide a reasonable level of absorption, the pump diode laser output wavelength should be between 910-980 nm to take advantage of what is commonly referred to as the E₃ energy level. If the pump diode laser wavelength exceeds 980 nm, the light will pass through the optical amplifier fiber with little absorption in this band and essentially no contribution to the gain of the optical fiber amplifier. If the pump laser wavelength drops to below 900 nm, the pump light absorption again drops to the point where the pump light fails to contribute effectively to the amplifier gain. Furthermore, it is desirable to pump the optical amplifier fiber at the long wavelength edge of the absorption band because the quantum defect energy is lower (and hence amplifier efficiency is higher) at the longer wavelengths. In light of these considerations, Er—Yb-doped optical amplifier fibers are typically pumped with a laser pump diode operated between 965-975 nm, and more typically with an output at nominally 970 nm at room temperature (20° C.). The specified wavelengths are center wavelengths of the pump laser diode, which typically has a half-power bandwidth of about 5 nm.

Unfortunately, the wavelength of pump laser diodes typically drifts with temperature, the wavelength increasing with increasing temperature (about 0.3 nm/° C.). An optical amplifier for a telecommunication application typically must operate over an ambient temperature range between 0-70° C. This can result in a wavelength shift of about 21 nm over the operating temperature range of the amplifier, or about 15 nm from room temperature to the higher temperature limit. If the pump laser diode has a nominal output wavelength at room temperature of 970 nm, the output wavelength might increase to 985 nm at 70° C. This shifts the wavelength beyond the upper absorption limit for typical Er—Yb-doped fibers, causing a sharp drop in amplifier operation when the band edge (980 nm) is crossed.

Thermo-electric coolers (“TECs”) are often used to maintain the pump diode laser chip temperature below the temperature at which the output wavelength would exceed the absorption band for the optical amplifier fiber. In many applications the TECs are used to maintain the temperature of the chip within a narrow range to stabilize the output wavelength of the pump laser diode. Unfortunately, TECs draw a relatively large amount of current, reducing the overall electrical-to-optical efficiency of the optical amplifier by a factor of approximately 2. Similarly, a TEC might fail in use, allowing the output wavelength of the pump laser diode to exceed the absorption band of the optical amplifier fiber, resulting in operational failure of the amplifier.

Another approach using active cooling is to globally cool the optical amplifier, such as by placing the optical amplifier in an air-conditioned cabinet. However, this also requires additional electrical power to operate and such cabinets often contain many optical components so that if the air conditioning fails many of the optical components might also fail.

Yet another approach avoids the need for active cooling (i.e. “coolerless operation”) by stabilizing the pump laser with a fiber Bragg grating (“FBG”). The FBG is a periodic structure formed in an optical fiber coupled to the output of the pump laser. The FBG has a narrow reflection characteristic that essentially locks the output of the laser to the wavelength or very near the wavelength of the reflected light. However, FBG's can only be written in single-mode fiber, thereby limiting their use to lower power, single-mode pump lasers. Such an approach for laser wavelength stabilization cannot be applied to higher power multimode pump lasers.

Therefore, it is desirable to provide an optical fiber amplifier that generates a high level of light output over a specified ambient temperature range without active cooling. It is further desirable that such optical fiber amplifiers provide good quantum efficiency and low sensitivity to pump laser diode output wavelength drift.

### BRIEF SUMMARY OF THE INVENTION

The present invention provides a coolerless optical fiber amplifier with good overall efficiency. A laser pump provides a relatively shorter wavelength at room temperature. At elevated temperatures, the wavelength of the laser pump typically drifts towards the upper absorption band edge of the optical amplifier fiber. The loss in quantum efficiency of the optical amplifier fiber resulting from pumping at a shorter wavelength is made up by not having to power an active cooling device, as with conventional pump modules that provide pump light at a wavelength closer to the absorption peak of the optical amplifier fiber.

In a particular embodiment, an optical amplifier has a pump laser module that provides a room-temperature (case) output wavelength of less than 965 nm. At the maximum specified case temperature of 70° C., the pump output wavelength is below the nominally 980 nm absorption band edge of optical amplifier fiber coupled to the pump source. The actual absorption peak typically occurs between about 970-980 nm, depending on the type of Er-doped or Er—Yb-doped optical fiber being used.

In another embodiment, an optical amplifier has a pump laser module providing pump output at between about 951-961 nm at room-temperature (20° C.), and providing a second output wavelength at a second case temperature of 70° C. The second output wavelength is less than the upper wavelength absorption band edge of the optical amplifier fiber.

### BRIEF DESCRIPTION OF THE DRAWINGS

FIG. 1 is a simplified top view of an optical fiber amplifier according to an embodiment of the present invention.

FIG. 2 is a graph of normalized absorption versus wavelength for Er—Yb-doped optical fibers co-doped with aluminum and phosphorous according to embodiments of the present invention.

FIG. 3 is a simplified flow chart of a process of operating a laser pump module according to an embodiment of the present invention.

### DETAILED DESCRIPTION OF THE INVENTION

The present invention provides an optical amplifier with a pump module that provides pump light to the optical amplifier fiber within its primary absorption band over the case temperature range of the pump module. This results in an optical amplifier with good overall electrical-to-optical efficiency, even though quantum efficiency is reduced compared to higher-wavelength pumping, because active cooling is not required. In other words, the optical amplifier is intended for “coolerless” applications.

I. Exemplary Optical Amplifier

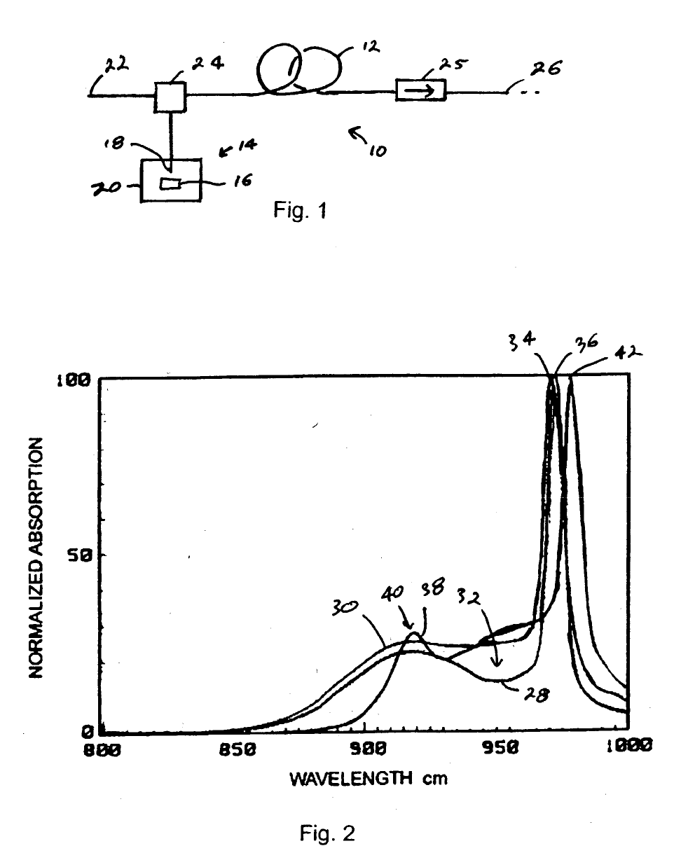

FIG. 1 is a simplified top view of an optical amplifier 10 according to an embodiment of the present invention. The amplifier includes an optical amplifier fiber 12 optically coupled to a laser pump module 14. The laser pump module could include a pump diode 16, for example, that couples pump light to an optical fiber pigtail 18. A laser pump chip is typically assembled on a substrate or mount, and then sealed in a package. The package typically includes feedthroughs for electrical power and the optical fiber pigtail. The package is commonly referred to as a module 20, and operating parameters of the laser pump module are often specified at a particular case temperature or over a range of case temperatures.

An optical signal, typically around 1550 nm in this example, is also coupled to the optical amplifier and provided at an amplifier input 22. A coupler 24 couples the optical signal and pump light to the optical amplifier fiber. Many techniques for such coupling are known in the art. An isolator 25, wavelength-selective filter, or other optical element(s) may be provided between the optical amplifier fiber section 12 and the amplifier output 26, and the optical amplifier may have several other components, such as gain-flattening filters, additional isolators, and noise filters, which are omitted for clarity of illustration.

The laser pump diode 16 has a nominal center wavelength (typically specified at room temperature) and a thermal drift characteristic, which is typically an increase in wavelength as temperature increases. The nominal center wavelength is generally the wavelength at the peak output power, and laser pumps often have a half-power bandwidth of about 5 nm, but this pump bandwidth is merely exemplary. The optical amplifier typically has a specified operating temperature range with a maximum temperature and a minimum temperature. For purposes of this patent application, when describing the operating temperature of the laser pump module, what is meant is the case temperature of the laser pump module. For example, “a laser pump operated at a temperature of 70° C.” means that the pump is operating at that case temperature, and not that the ambient temperature is necessarily 70° C. However, the temperature of the pump semiconductor laser chip is typically higher than the case temperature. The absorption characteristics of the optical amplifier fiber typically do not change much over the operating range of the optical amplifier.

The nominal center wavelength of the laser pump is chosen so that the nominal wavelength of light provided by the laser pump is less than the upper band edge of the relevant absorption band of the optical amplifier fiber over the specified operating temperature range of the optical amplifier. In another embodiment, the nominal center wavelength of the laser pump is chosen so that the nominal wavelength of light provided by the laser pump plus one-half the half-power bandwidth of laser pump is less than the upper band edge of the relevant absorption band of the optical amplifier fiber over the specified operating temperature range of the optical amplifier.

In a particular embodiment the upper band edge of the relevant absorption band is nominally 980 nm of the E₃ energy level in a Er-doped or Er—Yb-doped optical fiber. The peak absorption might occur between about 970-980 nm, depending on the composition of the glass that the amplifier fiber is made from. The upper band edge will be defined as the upper half-power point, commonly referred to as the “−3 dB” point, from the absorption peak.

The laser pump includes a laser diode with a thermal drift of about 0.3 nm/° C. and the case temperature range is 0-70° C. The laser diode typically has a half-power bandwidth of about 5 nm. In one instance the laser pump diode is chosen with a room-temperature (20° C.) nominal wavelength less than 965 nm. In another instance the laser pump diode is chosen with a room-temperature nominal wavelength less than 962.5 nm. It is particularly desirable to provide a laser pump with a nominal room-temperature wavelength between about 951-961 nm. Pumping the optical amplifier fiber with light at these wavelengths reduces the quantum efficiency of the amplifier compared to pumping at conventional wavelengths (between about 965-975 nm) but this reduction in quantum efficiency is mitigated by the overall amplifier efficiency achieved by not having to actively cool the optical amplifier. Pumping an optical amplifier fiber at the shorter wavelengths of the present invention is particularly desirable with Er—Yb co-doped fibers because the Yb doping facilitates absorption and conversion of these shorter wavelengths to useable amplification of the input signal.

II. Experimental Results Relating to Fiber Composition

FIG. 2 is a graph showing normalized absorption (%) versus wavelength for three optical amplifier fiber types. All of the fibers were silica-based (75-90 wt % SiO₂). While the optical amplifiers discussed in Section I relate to pumping at the 980 nm peak, the fibers represented in FIG. 2 can also be pumped at the 920 nm peak. Pumping at the primary, 980 nm peak provides high efficiency and good amplification of optical signals around 1550. Pumping at the 920 peak allows the optical amplifier fiber to lase at 1100 nm. Pump modules for pumping the 920 nm peak are typically operated at about 915 nm. Thermal drift of these pump modules can also affect gain and amplifier efficiency if the pump wavelength becomes offset from the peak. An object of the present invention is to flatten the 920 nm peak to lessen the effects of thermal drift of the pump module.

A number of optical fibers were prepared and measured. The first trace 28 is representative of the absorption for a first type of doped optical fibers. The compositions of fibers in this group was between 4-8 wt % Al₂O₃, 0-1.0 wt % P₂O₅, 0-3.5 wt % GeO₂, and less than 1.5 wt % Yb₂O₃, the remainder being SiO₂. The compositions fibers in the second group was 0.54 wt % Al₂O₃, 0-5 wt % P₂O₅, 1.5 wt % GeO₂, and less than 1.5 wt % Yb₂O₃. The compositions of fibers in the third group was 0-4.5 wt % Al₂O₃, 0-4.5 wt % P₂O₅, 0 wt % GeO₂, less than 1.5 wt % Yb₂O₃, and 0.05-0.5 wt % Er₂O₃.

The second trace 30 is representative of the second type of doped optical fiber. This type of fiber does not exhibit the absorption dip 32 between 920 nm and 975 nm, as the first type exhibits. The main absorption peak 34 has also shifted to a shorter wavelength compared to the main absorption peak 36 of the first type of fiber. The absorption peaks are not the energy band edges, but rather the wavelengths at which maximum absorption occurs. The band edge can be somewhat arbitrarily defined, but one common definition is the half-power point (also known as the −3 dB point) beyond (i.e. longer wavelength) the absorption peak. The absorption peak can be dependent on many factors. This fiber had a composition of greater than 4.5 wt % Al₂O₃, greater than 4.5 wt % P₂O₅, 0 wt % GeO₂, greater than 1.5 wt % Yb₂O₃, and 0.05-0.5 wt % Er₂O₃.

The third trace 38 is representative of a third type of doped optical fiber. This type of fiber flattens the absorption response between about 910 nm and about 972 nm, with a broad secondary peak at about 915 nm. Once again the primary absorption peak shifts slightly to a shorter wavelength. This fiber had a composition of greater than 0.1 wt % Al₂O₃, 16.5 wt % P₂O₅, 0 wt % GeO₂, 0.5-5.0 wt % Yb₂O₃, and 0.05-0.5 wt % Er₂O₃.

These results indicate that phosphorous doping is effective in flattening the absorption characteristic of Er—Yb co-doped fibers, as is doping with aluminum, especially in combination with phosphorous. In particular, co-doping Er—Yb fibers with aluminum and phosphorous in moderate amounts can provide greater than 20% normalized absorption between 905-970 nm (and longer) in Er—Yb co-doped fibers. This flattening of the absorption characteristic makes optical amplifiers using such fiber less sensitive to pump wavelength drift with pump sources operating in the 915 nm range. A normalized absorption of about 20% provides acceptable efficiency, in comparison to the response of doped fiber illustrated in the first trace 28, which not only would exhibit sensitivity in amplification characteristics to 915 nm pump wavelength drift, but also suffers from a normalized absorption of less than 20% over a portion of the relevant spectrum. Similarly, doping with higher amounts of phosphorous and even minor amounts of aluminum can remove the absorption dip between about 920-970 nm, and maintain better than 20% normalized absorption between about 940-970 nm. These fibers are typically pumped with high-power laser bars. It is difficult to control the exact wavelength yield for these bars, so the use of the absorption flattened fiber allows a much wider selection criteria (yield) for the pump lasers while maintaining laser/amplifier performance.

V. Exemplary Processes

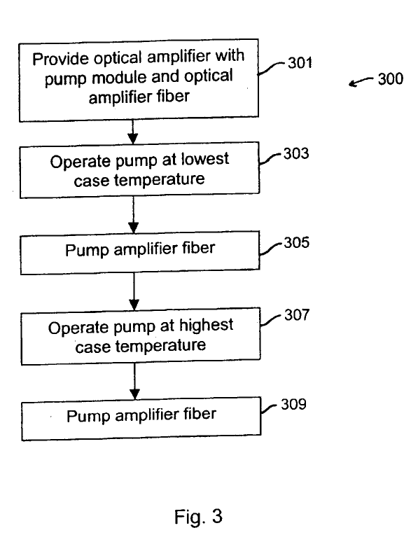

FIG. 3 is a simplified flow chart of a method of operating an optical amplifier 300. The optical amplifier is provided with a pump module and an optical amplifier fiber (step 301). The optical amplifier fiber has an absorption spectrum with an upper wavelength absorption band edge of about 980 nm (i.e. between about 970-980 nm). The pump module is operated at a lowest case temperature (step 303) to produce a pump output having a first nominal wavelength shorter than the upper wavelength absorption band edge of the optical amplifier fiber, and the pump output at the first nominal wavelength is coupled to the optical amplifier fiber (step 305). The pump module is then heated to a highest case temperature (step 307) to produce a pump output having a second nominal wavelength, also shorter than the upper wavelength absorption band edge of the optical amplifier fiber. The pump output at the second nominal wavelength is also coupled to the optical amplifier fiber (step 309). The optical amplifier fiber uses the light coupled from the pump to amplify an optical signal provided to the optical amplifier.

In a particular embodiment, the lowest case temperature is 0° C. and the highest case temperature is 70° C. In a particular embodiment, the first nominal wavelength and the second nominal wavelength of the pump output are both less than 965 nm, and in a further embodiment the first nominal wavelength is between 945-955 nm and the second nominal wavelength is between 966-976 nm. These numbers correspond to a room-temperature range of 951-961 and 0.3 nm/° C. drift, which is particularly desirable because use of these shorter wavelengths keeps the pump output below the absorption band edge with only a small impact on the quantum efficiency of the optical amplifier.

While the invention has been described in conjunction with several specific embodiments, it is evident to those skilled in the art that many further alternatives, modifications, and variations will be apparent in light of the foregoing description. For example, although embodiments with Er—Yb-doped fibers have been described, other dopants, such as fluorine, could be added to the doped fibers. Similarly, the present invention might be utilized or implemented with multi-stage amplifiers, recycled pump power, input signal bands other than 1550, Er:Yb:glass solid-state laser pumping, or Yb:glass solid-state lasers. Thus, the invention described herein is intended to embrace all such alternatives, modifications, applications, and variations as may fall within the spirit and scope of the following claims.

What is claimed is:

1. An optical amplifier comprising:
a pump laser module having a first pump wavelength at room temperature and a second pump wavelength at a highest operating temperature of the optical amplifier, the pump laser module being configured to optically couple the pump output to
an optical amplifier fiber having an upper wavelength atomic absorption band edge, the second pump wavelength being less than the upper wavelength atomic absorption band edge.

2. The optical amplifier of claim 1 wherein the first pump wavelength is less than 965 nm.

3. The optical amplifier of claim 1 wherein the highest operating temperature is 70 ° C.

4. The optical amplifier of claim 1 wherein the upper wavelength absorption band edge is less than or equal to 980 nm.

5. The optical amplifier of claim 1 wherein the laser pump module has a room temperature output wavelength less than about 962.5 nm.

6. The optical amplifier of claim 1 wherein the laser pump module has a room temperature output wavelength of between about 951-961 nm.

7. The optical amplifier of claim 6 wherein the upper wavelength absorption band edge is at least 976 nm.

8. The optical amplifier of claim 1 wherein the optical amplifier fiber is co-doped with Er and with Yb.

9. The optical amplifier of claim 8 wherein the optical amplifier fiber comprises at least about 0.05 weight % Er₂O₃.

10. The optical amplifier of claim 1 wherein the optical amplifier fiber comprises at least about 0.05 weight % Er₂O₃ and at least 0.5 weight % Yb₂O₃.

11. An optical amplifier comprising:
a pump laser module providing a pump output at a first output wavelength of less than 965 nm at 20° C., and a second output wavelength at a temperature of 70° C., the pump laser module being configured to optically couple the pump output to an optical amplifier fiber having an upper wavelength atomic absorption band edge between about 970-980 nm, wherein the second output wavelength is less than the upper wavelength atomic absorption band edge.

12. The optical amplifier of claim 11 wherein the upper wavelength atomic absorption band edge is at least 975 nm.

13. The optical amplifier of claim 11 wherein the first output wavelength is greater than about 951.

14. An optical amplifier comprising:
a pump laser module providing pump output at
a first output wavelength between about 951-961 nm at a first case temperature of 20° C., and at
a second output wavelength at a second case temperature of 70° C., the pump laser module being configured to optically couple the pump output to
an optical amplifier fiber having an upper wavelength absorption band edge, wherein the second output wavelength is less than the upper wavelength absorption band edge of the optical amplifier fiber.

15. An optical amplifier fiber comprising:
SiO₂;
Yb₂O₃;
Er₂O₃;
Al₂O₃; and
P₂O₅, the optical amplifier fiber having an absorption peak between about 970-980 nm and a normalized absorption of at least 20% of the absorption peak from at least about 940 to about 970 nm.

16. The optical amplifier fiber of claim 15 having the normalized absorption of at least 20% from about 905 nm to about 970 nm.

17. A silica-based optical amplifier fiber comprising:
at least 1.5 weight % Yb₂O₃;
at least 0.05 weight % Er₂O₃;
at least 4.5 weight % Al₂O₃; and
at least 4.5 weight % P₂O₅.

18. The silica-based optical amplifier fiber of claim 17 comprising 0.1-0.5 weight % Er₂O₃.

19. A silica-based optical amplifier fiber comprising:
at least 0.5 weight % Yb₂O₃;
between 0.05-0.5 weight % Er₂O₃;
greater than 0.1 weight % Al₂O₃; and
sixteen weight % P₂O₅.
